(19) United States
(12) Patent Application Publication
(10) Pub. No.: US 2013/0088180 A1
(43) Pub. Date: Apr. 11, 2013

(54) OUTSIDE MIRROR CONTROL METHOD OF VEHICLE

(71) Applicants: Hyun Sub Kim, Seoul (KR); Jun Mo Ku, Hwaseong-si (KR)

(72) Inventors: Hyun Sub Kim, Seoul (KR); Jun Mo Ku, Hwaseong-si (KR)

(73) Assignees: Kia Motors Corp., Seoul (KR); Hyundai Motor Company, Seoul (KR)

(21) Appl. No.: 13/492,384

(22) Filed: Jun. 8, 2012

(30) Foreign Application Priority Data
Oct. 11, 2011 (KR) 10-2011-0103653

(51) Int. Cl. H02P 3/06

(52) U.S. Cl. 318/400.42

(57) ABSTRACT

A vehicular outside-mirror control method may improve durability of a motor by appropriately controlling the motor according to a condition of peripheral temperature so as to prevent the motor implementing a folding function of the outside mirror from being damaged and improve assembling workability and save costs of a vehicle by reducing the number of wires connected with the door while performing various functions to be implemented by the outside mirror.

### CROSS-REFERENCE TO RELATED APPLICATION

The present application claims priority of Korean Patent Application Number 10-2011-0103653 filed Oct. 11, 2011, the entire contents of which application is incorporated herein for all purposes by this reference.

### BACKGROUND OF INVENTION

1. Field of Invention

The present invention relates to an outside mirror control method of a vehicle, and more particularly, to a technology regarding a method for controlling a driving motor responsible for a driving of an outside mirror.

2. Description of Related Art

Recently, an outside mirror of a vehicle has been added with various functions. As a result, various functions, such as a power folding, a glass angle control, a heat ray function, or the like.

In the related art, in order to perform various functions as described above, a plurality of electrical wires from a door need to connect to the outside mirror and therefore, an assembling work may be complicated, cost may be increased, and an occurrence possibility of fault may be increased.

Meanwhile, the outside mirror needs to drive a motor so as to perform the folding function. In the related art, a controller driving the motor drives a motor for a predetermined time expected as the folding operation of the outside mirror is completed and then, when the folding operation is completed, the operation of the motor is no more rotated. Therefore, when generated stall current is sensed, the motor stops so as to complete the folding operation.

However, since the stall current of the motor has characteristics changed according to temperature, the relate art controls the motor according to the predetermined stall current without considering an effect of temperature, such that the motor may be damaged.

That is, the stall current of the motor is changed according temperature and operating voltage. In particular, as the temperature rises, the stall current tends to be reduced. When the stall current constantly set even under the high-temperature condition is higher than the actual stall current, the motor is continuously driven forcibly, such that the motor may be damaged.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an outside mirror control method of a vehicle capable of improving durability of a motor by appropriately controlling a motor according to a condition of peripheral temperature so as to prevent a motor implementing a folding function of the outside mirror from being damaged and an outside mirror control apparatus of a vehicle capable of improving assembling workability and saving costs of a vehicle by reducing the number of wires connected with a door while performing various functions to be implemented by the outside mirror.

Various aspects of the present invention provide for an outside mirror control method of a vehicle including forming a data map for stall current of a motor in a predetermined temperature range, measuring present temperature, obtaining stall current according to the present temperature from the data map, and stopping a driving of the motor when the stall current is sensed when a folding of the outside mirror is operated.

Various aspects of the present invention provide for an outside mirror control method of a vehicle including measuring present temperature, obtaining stall current according to the present temperature from a data map for the stall current of the motor in a predetermined temperature range, and stopping a driving of the motor when the stall current is sensed at the time of the folding operation of the outside mirror.

Various aspects of the present invention provide for an outside mirror control apparatus of a vehicle including a storage device storing the data map configured of data of stall current according to a predetermined temperature range, a temperature sensor measuring present temperature, and a controller stopping a driving of the motor when operating current of the motor reaches the stall current at the time of a folding operation of the outside mirror by obtaining the stall current corresponding to the present temperature measured from the temperature sensor from the data map of the storage device.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flow chart of an exemplary outside mirror control method of a vehicle according to the present invention.

FIG. 2 is a diagram showing an exemplary data map for implementing a control method according to the present invention.

FIG. 3 is a flow chart of an exemplary outside mirror control method of a vehicle according to the present invention.

FIG. 4 is a block diagram showing an exemplary outside mirror control apparatus for a vehicle according to the present invention.

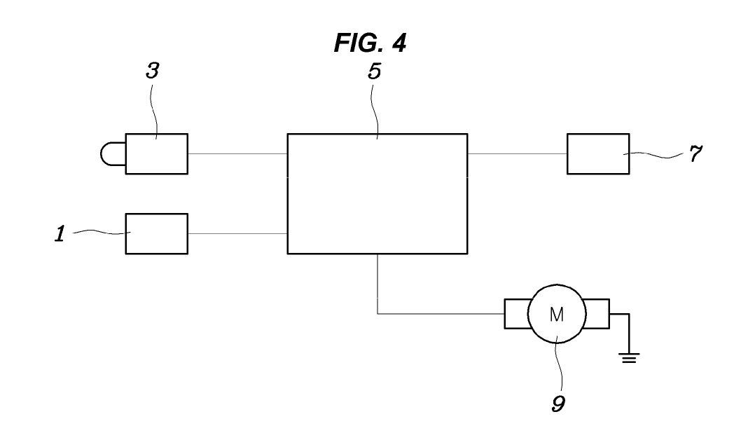

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

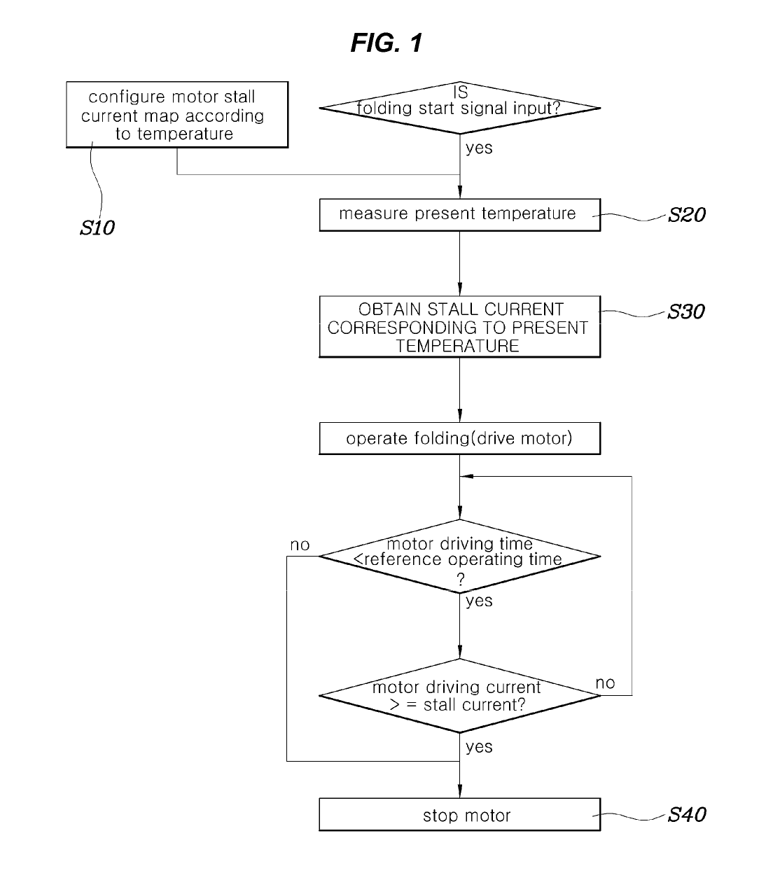

Referring to FIG. 1, an outside mirror control method according to various embodiments of the present invention may include forming a data map for stall current of a motor in a predetermined temperature range (S10), measuring present temperature (S20), obtaining stall current according to the present temperature from the data map (S30), and stopping a driving of the motor when the stall current is sensed when a folding of the outside mirror is operated (S40).

That is, a damage of the motor may be prevented by previously forming the data map so as to consider a change in the stall current of the motor according to the temperature, measuring temperature at the time when the folding operation of the outside mirror is performed, and driving the motor and then stopping the motor based on a stall current value corresponding to the temperature.

The control method performs the measuring of the temperature (S20) and drives the motor for a predetermined reference operating time when a folding start signal of the outside mirror is input and performs the stopping of the motor (S40) when current applied to the motor reaches the stall current before the reference operating time lapses.

Herein, the folding start signal of the outside mirror may perform a switch operation of a driver according to a vehicle and automatically perform the folding operation of the outside mirror when an engine starting of a vehicle is turned-off.

The predetermined reference operating time is generally the predetermined time when the folding of the outside mirror completes, which is previously determined and stored by a plurality of tests.

Meanwhile, the forming of the map (S10) obtains and stores the stall current of the motor for each operating voltage applied to the motor in each predetermined temperature range and the obtaining of the stall current (S30) may obtain the stall current according to the present temperature and the operating voltage provided by the present battery.

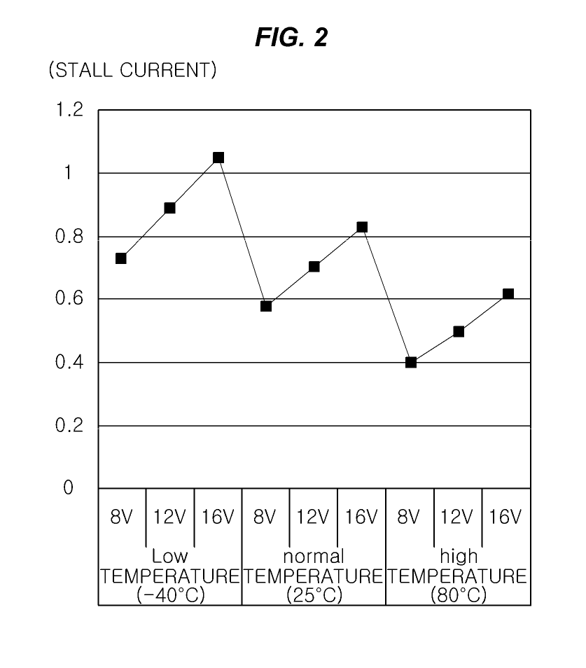

That is, as shown in FIG. 2, the stall current of the motor is different according to each temperature range but the stall current of the motor is changed even in the same temperature range according to the size of the operating voltage provided by the battery. In order to consider the above condition, the maps of the stall current for each temperature range and each operating voltage are provided, thereby performing the control of the motor.

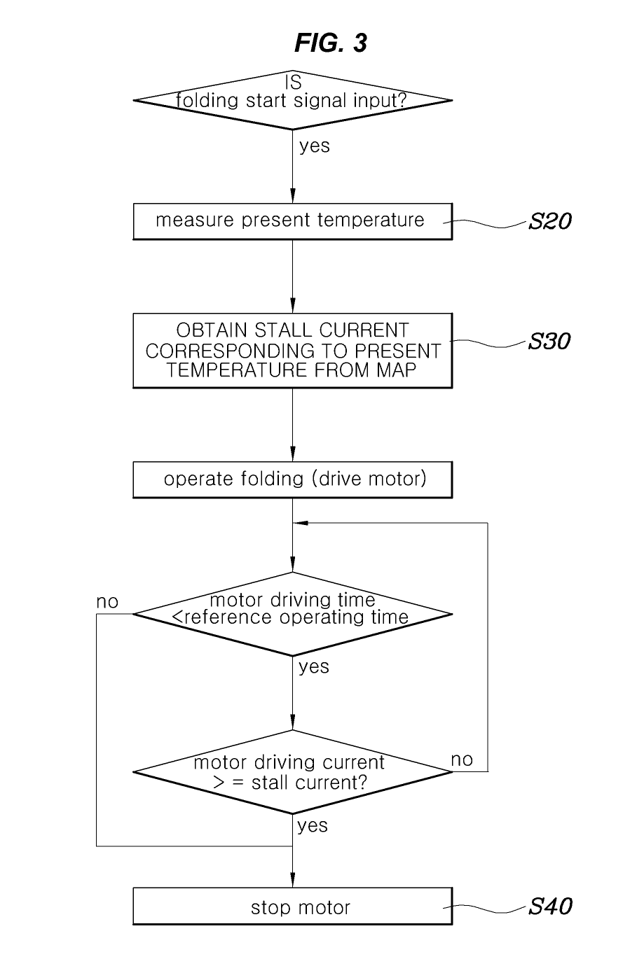

Meanwhile, although the above-mentioned control method includes the forming of the map (S10), in the substantial vehicle, the forming of the map (S10) is previously completed at the time of the developed of the vehicle so as to be used by storing only the result in a storage device. Accordingly, as shown in FIG. 3, the outside mirror control method of a vehicle according to various embodiments of the present invention may include measuring the present temperature (S20), obtaining the stall current according to the present temperature from the data map for the stall current of the motor in the predetermined temperature range (S30), and stopping the driving of the motor when the stall current is sensed at the time of the folding operation of the outside mirror (S40).

Meanwhile, the outside mirror control apparatus of a vehicle according to various embodiments of the present invention in order to implement the above-mentioned control method may include a storage device 1 storing the data map configured of data of the stall current according to the predetermined temperature range, a temperature sensor 3 measuring the present temperature, and a controller 5 stopping the driving of the motor 9 when the operating current of the motor reaches the stall current at the time of the folding operation of the outside mirror by obtaining the stall current corresponding to the present temperature measured from the temperature sensor 3 from the data map of the storage device 1.

Further, the data map of the storage device 1 is configured to include the data of the stall current according to the operating voltage provided by the battery for each temperature range and the controller 5 is configured to stop the driving of the motor when the operating current of the motor reaches the stall current by obtaining the stall current according to the present temperature and the operating voltage provided by the present battery.

In addition, the control apparatus according to various embodiments of the present invention includes an LIN module 7 that is mounted on the outside mirror so as to perform local interconnect network (LIN) communication with another control module. That is, the control apparatus receives a command of the operation of various functions by the LIN communication with the door control module, or the like, mounted on the door and transmits and receives the signal involved in the command, thereby minimizing the number of wires connected to the outside mirror from a vehicle body such as the door, or the like.

As described above, when the outside mirror control apparatus is mounted on the outside mirror to transmit and receive the information by the LIN communication, the number of wires connecting the control apparatuses in the vehicle to the outside mirror is minimized, thereby reducing the number of parts, improving the assembling workability, and saving the costs of the vehicle.

As set forth above, various embodiments of the present invention can improve the durability of the motor by appropriately controlling the motor according to the condition of peripheral temperature so as to prevent the motor implementing the folding function of the outside mirror from being damaged and improve the assembling workability and save the costs of a vehicle by reducing the number of wires connected with the door while performing various functions to be implemented by the outside mirror.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control method for an outside mirror of a vehicle, the method comprising:
forming a data map for stall current of a motor in a predetermined temperature range;
measuring a present temperature;
obtaining a stall current according to the present temperature from the data map; and
stopping the motor when the stall current is sensed when a folding of the outside mirror is operated.

2. The method of claim 1, wherein the measuring of the present temperature is performed and the motor is activated for a predetermined reference operating time, when a folding start signal of the outside mirror is input, and
the stopping the motor is performed when current applied to the motor reaches the stall current before the reference operating time lapses.

3. The method of claim 1, wherein the forming the data map obtains and stores the stall current of the motor for each predetermined operating voltage applied to the motor in each temperature range, and
the obtaining of the stall current obtains the stall current according to the present temperature and the operating voltage provided by the present battery.

4. An outside mirror control method of a vehicle, comprising:
measuring a present temperature;
obtaining a stall current according to the present temperature from a data map for the stall current of the motor in a predetermined temperature range; and
stopping a driving of the motor when the stall current is sensed at the time of the folding operation of the outside mirror.

5. The method of claim 4, wherein the measuring of the temperature is performed and the motor is driven for a predetermined reference operating time when a folding start signal of the outside mirror is input, and
the stopping of the motor is performed when current applied to the motor reaches the stall current before the reference operating time lapses.

6. The method of claim 5, wherein the data map for the stall current of the motor in the predetermined temperature range is configured to include data of the stall current according to the operating voltage provided by the battery for each temperature range, and
the obtaining of the stall current obtains the stall current according to the present temperature and the operating voltage provided by the present battery.

7. An outside mirror control apparatus of a vehicle, comprising:
a storage device storing a data map of a stall current according to a predetermined temperature range;
a temperature sensor measuring a present temperature; and
a controller stopping a motor when operating current of the motor reaches the stall current at the time of a folding operation of the outside mirror by obtaining the stall current corresponding to the present temperature measured from the temperature sensor from the data map of the storage device.

8. The apparatus of claim 7, wherein the data map of the storage device 1 includes the data of the stall current according to the operating voltage provided by the battery for each temperature range, and
the controller is configured to stop the driving of the motor when the operating current of the motor reaches the stall current by obtaining the stall current according to the present temperature and the operating voltage provided by the present battery.

9. The apparatus of claim 8, further comprising an LIN module provided so as to perform local interconnect network (LIN) communication with another control module.
